(19) United States
(12) Patent Application Publication
(10) Pub. No.: US 2006/0117622 A1
(43) Pub. Date: Jun. 8, 2006

(54) Advertisement print and a method of generating an advertisement print

(75) Inventor: Christian Sondergaard, NORRE-SNEDE (DK)

Correspondence Address: PITNEY HARDIN LLP, 7 TIMES SQUARE, NEW YORK, NY, 10036-7311, US

(73) Assignee: LP HOLDINGS APS, VEJLE (DK)

(21) Appl. No.: 10/533,274

(22) PCT Filed: Nov. 6, 2003
(86) PCT No.: PCT/DK03/00761

§ 371 Date: Oct. 28, 2005

(30) Foreign Application Priority Data
Nov. 6, 2002 (EP) 02388070.1

(51) Int. Cl. G09F 7/00

(52) U.S. Cl. 40/596

(57) ABSTRACT

The invention relates to a method of generating an advertisement print comprising advertisement information, where the advertisement print is adapted for being positioned on a surface of a substantially plane print carrier, where the substantially plane print carrier has a predefined surface area. The method comprises the step of projecting the predefined surface area to a plane perpendicular to a line of sight between a predefined viewpoint and the print carrier, placing the advertisement information within boundaries of the projected predefined surface area and generating the advertisement print by graphically transforming the projected predefined surface area together with the advertisement information to an area similar to the predefined surface area of the substantially plane print carrier. The invention further relates to an advertisement print being printed on a substantially plane print carrier. The print is optimised to be placed on a surface of an inclined plane having a first inclination, and the print comprises a first element being a perspective projection of a first three-dimensional element to the inclined plane. The projection is optimised to a predefined viewpoint, where a supporting surface of the three dimensional element is parallel to a supporting plane having a second inclination being different from the first inclination.

### FIELD OF THE INVENTION

The invention relates to a method of generating an advertisement print comprising advertisement information, where the advertisement print is adapted for being positioned on a surface of a substantially plane print carrier. The invention also relates to a computer readable medium having stored therein instructions for causing a processing unit to execute the method of generating an advertisement print. The invention also relates to an advertisement print, an advertisement board and a sports arena comprising an advertisement board.

### BACKGROUND OF THE INVENTION

The use of advertising has increased heavily during the past years and is used in different forms such as TV commercials, Internet advertisement, advertisements in newspapers and magazines and static printed advertisements being placed in the environment both outdoors and indoors with the purpose of advertising for the people passing by the advertisement.

With regard to static printed advertisement, a problem is often that people do not notice the advertisement, mainly because they are getting used to advertisements, which makes it more and more difficult to attract people's attention. Another problem with the printed advertisements is that they are limited for presenting information in two dimensions, which limits the type of information that can be expressed by a static printed advertisement. This is especially the case when the viewer is not positioned at 90° (or close to that) in front of the advertisement.

Typically in connection with e.g. a sporting event on a field such as soccer, basketball, ice hockey, tennis, baseball and handball, a number of advertising boards are placed around the playing field and different advertisements are placed on different boards. Also, in this kind of advertising the viewers are getting used to the boards and therefore tend to stop noticing the boards and the two-dimensional image positioned on top of the boards. Further, even if the viewers notice the boards, it is of great interest to the advertiser that their advertisement board is more noticeable than the other boards.

### OBJECT AND SUMMARY OF THE INVENTION

It is therefore an object of the present invention to obtain a method of generating an advertisement print that can be used on e.g. existing advertising boards increasing the commercial value of advertising on advertising boards. This is obtained by a method of generating an advertisement print comprising advertisement information, where the advertisement print is adapted for being positioned on a surface of a substantially plane print carrier, where said surface has a predefined surface area. The method comprises the steps of:
projecting the predefined surface area to a plane perpendicular to a line of sight between a predefined viewpoint and said print carrier,
placing the advertisement information within boundaries of said projected predefined surface area,
generating said advertisement print by transforming the projected predefined surface area together with the advertisement information to an area similar to said predefined surface area of said substantially plane print carrier.

The predefined surface area is an area having not only the same area but also the same dimensions as the surface of the plane print carrier. The transformation can be performed as a graphical transformation by stretching and/ or rotating the projected predefined surface area together with the advertisement information. By the present invention a visual illusion can easily be generated from predefined viewpoints as soon as the predefined surface area has been projected to the plane; then the only limiting factor is the creativity of the designer designing the advertisement information and the boundaries of the projected predefined surface area within which the design needs to be placed. The special effect is optimised for viewers positioned near or at the predefined viewpoint, which could be used for directing specific advertisement information to specific groups of people. In a sport game having supporters for each team, some advertisements could be optimised for one group of supporters, and other advertisements could be optimised for another group of supporters. Using this method it is especially easy to create visual impressions of three dimensional elements by performing a perspective projection of the element to the inclined surface of a print carrier, e.g. an advertisement board.

In a specific embodiment the advertisement information is two-dimensional having a first and a second dimension, and where a first dimension of the advertisement information is made parallel to a boundary of the projected predefined surface area. Thereby the advertisement information appears more natural for the viewer and in case the advertisement information is supposed to give a three-dimensional illusion, then this illusion is enhanced. Further, the more natural appearance makes the advertisement less disturbing for the viewer.

In an embodiment the predefined surface area is the surface area of an advertisement board in a sports arena. Especially in this field, the invention has a lot of advantages since a lot of people are often gathered at the sports arena, and thereby the advertisers can easily get their message out to a large number of people.

In yet another embodiment, a third dimension of the advertising information is made parallel to lines on the sports arena. Thereby the advertisement seems more natural and the three-dimensional effect appears more realistic.

In an embodiment the predefined viewpoint is defined as the position of a broadcasting camera. Thereby an even larger number of people get the advertisement information.

The invention also relates to an advertisement print comprising advertisement information, where the advertisement print is adapted for being positioned on a substantially plane surface of a print carrier, said surface having a predefined surface area and is parallel to an inclined plane having a first inclination relative to the ground supporting said print carrier of more than 0 degrees, said advertisement print comprising a first element being a perspective projection of at least a first three-dimensional element to said inclined plane, where said perspective projection is based on a predefined viewpoint.

Thereby an improved advertising effect can be obtained, and when the predefined surface area of the print carrier is being viewed from the predefined viewpoint, then a three-dimensional element appears to be in a virtual space in the advertisement print, which first of all gives a more powerful advertisement but also results in an advertisement print that can be used for a larger variety of advertising purposes taking advantage of the virtual space.

In a specific embodiment the supporting surface of said three-dimensional element is parallel to a supporting plane having a second inclination being different from said first inclination. Thereby a three-dimensional element appears to be standing on a supporting surface different from the surface of the advertising board further enhancing the effect of both the three dimensional element and the virtual space.

In an embodiment the print further comprises a second element illustrating said supporting plane. This could further enhance the effect of both the three dimensional element and the virtual space.

In an embodiment the inclination of said supporting plane is substantially the same as the inclination of a surface supporting said print carrier. Thereby the advertisement seems more natural compared to the surroundings and the visual illusion is stronger.

In an embodiment the surface area of the print carrier is a plane having a first inclination between 0 degrees and 90 degrees, but different from 0 degrees. This is typically the case for advertisement boards placed in sport arenas around the sport field. Normally the inclination is above 0 degrees, but it is often 90 degrees.

In an embodiment the surface of the substantially plane print carrier is the surface of an advertisement board in a sports arena. Especially in this field, the invention has a lot of advantages since a lot of people are often gathered at the sports arena, and thereby the advertisers can easily get their message out to a large number of people.

In an embodiment the viewpoint is defined as the position of a broadcasting camera. Thereby an even larger number of people get the advertisement information correctly.

In an embodiment the three dimensional element comprises three-dimensional letters having a depth extending parallel to the surface supporting said print carrier, whereby the three dimensional letters appear to be supported on a plane being parallel to the surface supporting said print carrier. Often advertisements comprise words being e.g. the name of a company or a product. By using three dimensional letters as described above, a very strong advertisement is obtained, where both the three dimensional element and the virtual space is clear.

The invention further relates to an advertisement board in a sports arena comprising a substantially plane print carrier with advertisement print containing advertisement information, where the advertisement print is adapted for being positioned on a surface of the substantially plane print carrier, where the substantially plane print carrier has a predefined surface area, the surface area of the print carrier is a plane having a first inclination relative to the surface supporting the advertisement board being different from 0 degrees, said advertisement print comprising a first element being a perspective projection of at least a first three-dimensional element to said inclined plane, where said perspective projection is based on a predefined viewpoint.

The invention further relates to a sports arena with a field and lines on the field, a broadcasting camera and an advertisement board comprising a substantially plane print carrier with advertisement print containing advertisement information, where the advertisement print is adapted for being positioned on a substantially plane surface of the print carrier, where the substantially plane print carrier has a predefined surface area, the surface area of the print carrier is a plane having a first inclination relative to the surface supporting the advertisement board being different from 0 degrees, said advertisement print comprising a first element being a perspective projection of at least a first three-dimensional element to said inclined plane, where said perspective projection is based on a predefined viewpoint defined as the position of said broadcasting camera.

The invention also relates to a computer readable medium having stored therein instructions for causing a processing unit to execute the method of generating an advertisement print.

### BRIEF DESCRIPTION OF THE DRAWINGS

In the following, preferred embodiments of the invention will be described referring to the figures, wherein

FIG. 1a and 1b illustrate the method according to the present invention,

FIG. 2 illustrates the stretching performed to generate the advertisement print,

FIG. 3 illustrates how advertisement information can be placed within the boundaries of the projected predefined surface area,

FIG. 4 illustrates a number of embodiments of the designs within the projected predefined surface area,

FIG. 5a and 5b illustrate the method according to the present invention being performed when designing a print to be used for print carrier having a predefined surface area being parallel to an inclined plane with an inclination of approximately 90 degrees relative to the ground,

FIG. 6a and 6b illustrate the method according to the present invention similar to the example given using FIG. 5a and 5b, but optimising the print to another viewpoint,

FIG. 7 illustrates a sports arena comprising an advertisement board according to the present invention.

### DESCRIPTION OF PREFERRED EMBODIMENTS

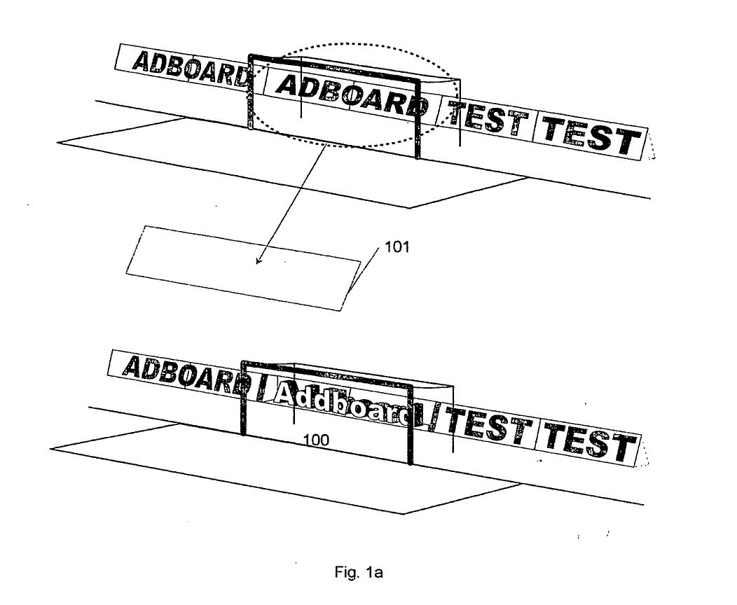

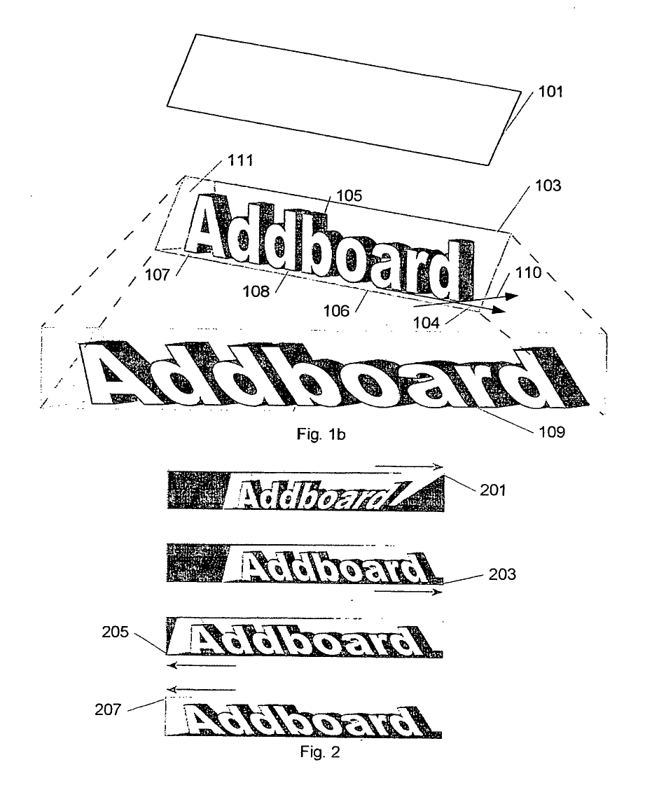

In FIGS. 1a and 1b the method of generating a print according to the present invention is illustrated. In the described embodiment the predefined surface area is the surface area of an advertising board being the surface normally used for placing advertisement information when using the boards for advertising. Further, in this example the advertisement board is then the print carrier First, a view of only the surface area of the advertising board, from a predefined viewpoint, is generated by projecting the predefined surface area to a plane perpendicular to a line of sight between the predefined viewpoint and the print carrier. The projected surface area is illustrated in 101. The projected could e.g. be generated in a drawing program for a computer by using knowledge about the position of the advertising board in relation to the position of the predefined viewpoint, which the advertising should be optimised for or based on. Alternatively, a photo of the surface area could be taken is from the predefined viewpoint, and the boundaries of the surface area could then be found on the photo, whereby the predefined surface area is projected to a plane perpendicular to a line of sight between the predefined viewpoint and the print carrier. The predefined surface area of the advertising board is a surface of an inclined plane e.g. compared to the surface area of the field on a sports arena. In another embodiment the predefined surface area could be a plane having an inclination of 0 degrees with the field on the sports arena or an inclination of 90 degrees with the field on the sports arena.

When the projected predefined surface area has been generated as illustrated in 101, the next step is to place the advertisement information within boundaries of the predefined surface area 101. By ensuring that the advertising information is within the boundaries of the projected predefined surface area 101, the advertising information can have all kinds of shapes and effects. The graphical impression of what is being placed within the area will be the same impression that a viewer will get when seeing the surface of the advertising board, on which the generated advertisement print has been placed.

In 103, the three-dimensional letter “Addboard” 105 have been drawn within the boundaries, and it has been ensured that a first dimension 104 of the letters, which also can referred to as the baseline of the letters, is parallel to a boundary 106 of the projected predefined surface area 101. It is also to be noticed that the supporting surface 108 of the letters “Addboard” 105 being the lower surface of the letters or the bottom of the letters on which the letters appears to be resting, is made parallel to the illustration of a supporting plane 107 having a second inclination being different from the first inclination. Using other words the supporting surface 108 can be defined as being parallel to a plane spanned by the baseline or first dimension 104 of the letters and the depth 110 of the letters.

In the present example the supporting surface 108 appears to be resting on the illustration of the supporting plane 107, but in alternative examples the supporting surface 108 could e.g. be placed with a distance above the supporting plane 107, whereby the letters would appear to be floating above the supporting plane 107. The supporting plane 107 is illustrated to enhance the effect of the perspective projection performed to the inclined plane. To further enhance the effect, a side plane 111 has been added, and an effect of a virtual three dimensional space within the print carrier appears.

Now the desired effect that should be obtained from the predefined viewpoint when seeing the surface of the advertising board is simulated, and the next step is to make an advertisement print being adapted for being positioned on the predefined surface area and thereby have the same area and dimension as the predefined surface area of the advertising board. In other words, a print needs to be generated that can be positioned on the inclined plane of the advertising board, whereby the effect can be obtained. In 109, a perpendicular view of the advertisement print has been made whereby the advertisement print can be printed. First, the size is found and thereby the boundaries of the predefined surface area, then the simulation is transformed (e.g. by rotation and stretching) as shown in 109, and a print is ready to be printed and afterwards positioned on the surface of the advertising board. As illustrated in FIG. 1a, the stretched design has been positioned on the surface of the advertisement board and when being viewed at, by the viewer, the advertisement appears as illustrated in 100.

In FIG. 2 it is illustrated how the stretching can be performed for each corner, as shown in 201, 203, 205 and 207, until the advertisement print has an area and dimension similar to the area and dimension of the predefined surface of the print carrier on which the print is to be placed.

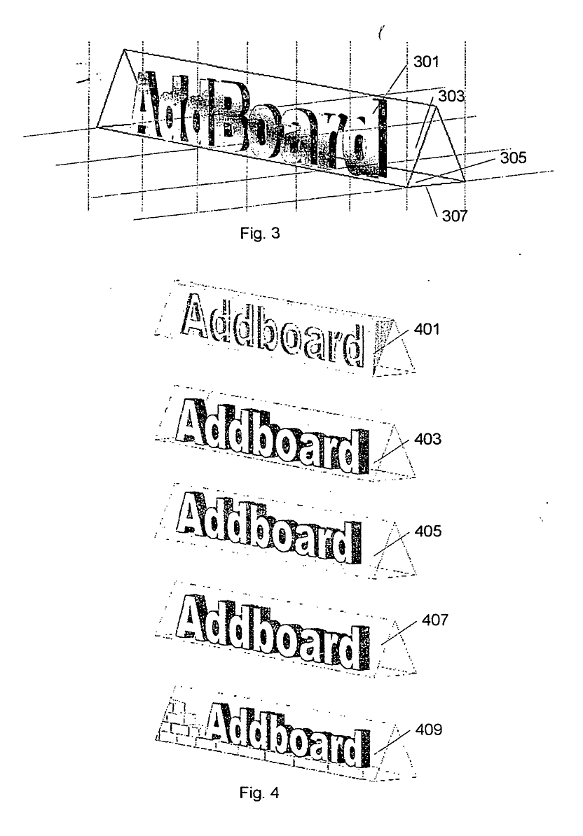

In FIG. 3 it is illustrated how the advertisement information 301 is placed within the boundaries of the projected predefined surface area 303. Further, it has been ensured that the words are written on a line being parallel to the bottom line of the projected predefined surface area. In this case the advertisement print is to be used on an advertisement board and also an illustration of the surface 305, supporting the advertising board, has been projected to the plane perpendicular to a line of sight between the predefined viewpoint and the surface of the print carrier. By doing this, the advertisement information can have a third dimension being substantially parallel to supporting lines 307 of the advertising board.

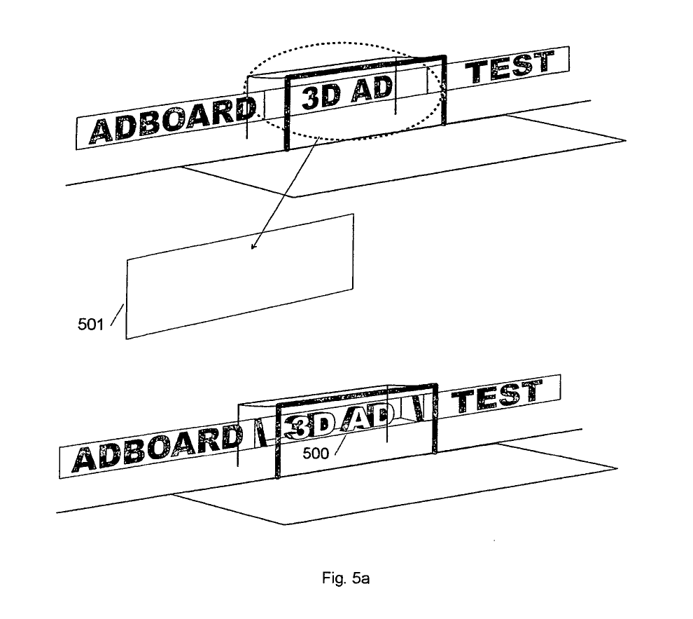

FIG. 4 illustrates a number of designs that can be made within the projected predefined surface area of an advertising board. In 401, the advertisement print that can be generated by performing the rotation and the stretching of the projected predefined surface area will appear to be a vertical wall onto which the letters have been pressed. This illusion will be obtained when mounting the generated advertisement print on the predefined surface area of the advertising board and then looking at the board from the predefined viewpoint. In 403, the illusion will be three-dimensional letters standing on a surface, and behind the surface a squared inclined wall is placed. In 405, the three-dimensional letters are standing on a cylinder shaped block. In 407, the letters are standing on a surface having an inclination being similar to the surface on which the advertisement board is resting, and in 409, bricks have been positioned around the letters. A few examples have been given of how different illusions can be made, but in general there is no limit as to what is being designed, as long as the advertising information is positioned within a projected predefined surface area.

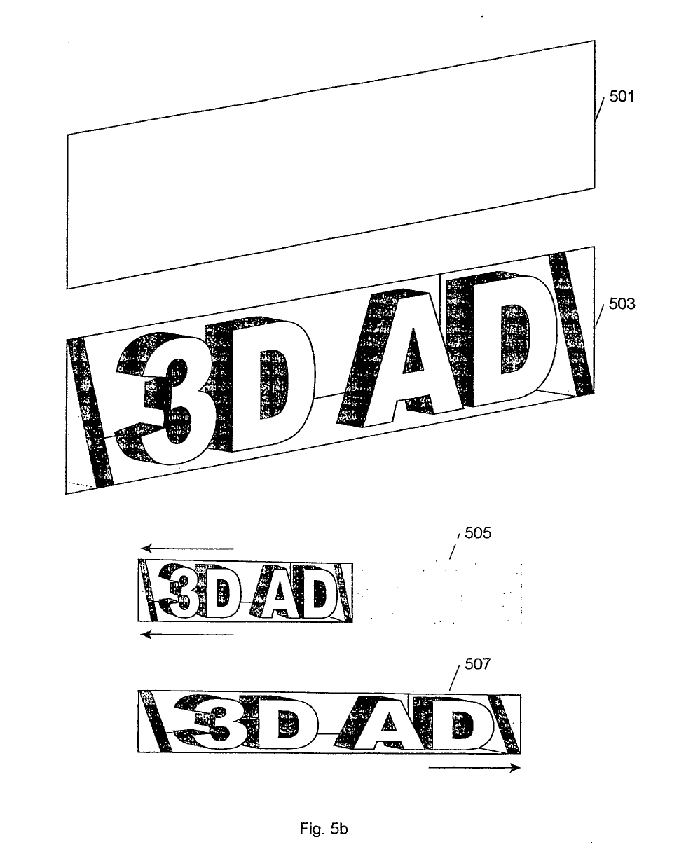

In FIGS. 5a and 5b the method according to the present invention is illustrated being performed when designing a print to be used for print carrier having a predefined surface area being parallel to an inclined plane with an inclination of approximately 90 degrees relative to the ground. When the projected predefined surface area has been generated as illustrated in 501, the next step is to place the advertisement information within boundaries of the predefined surface area 501. This has been performed in 503. Finally the stretching is performed for each corner, as shown in 505 and 507, until the advertisement print has an area and dimension similar to the area and dimension of the predefined surface of the print carrier on which the print is to be placed. As illustrated in FIG. 5a the stretched design has been positioned on the surface of the advertisement board and when being viewed at, by the viewer, the advertisement appears as illustrated in 500.

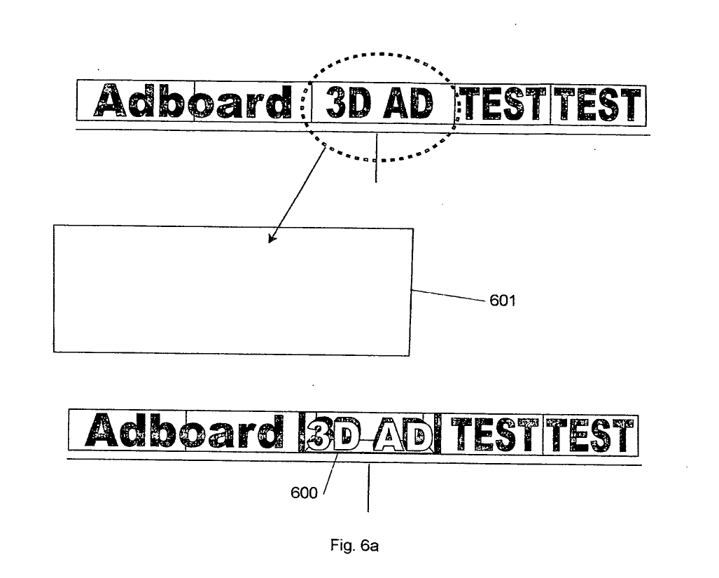

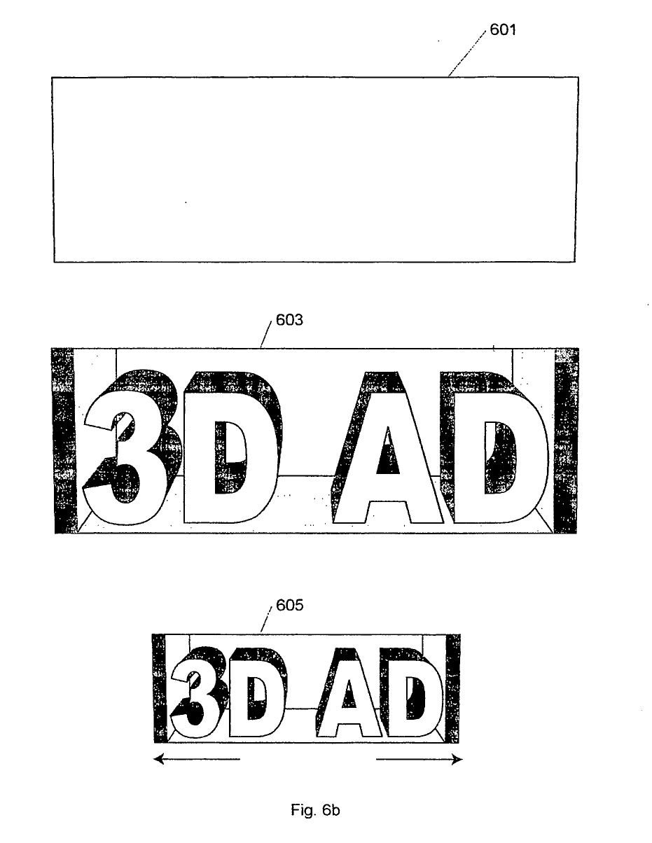

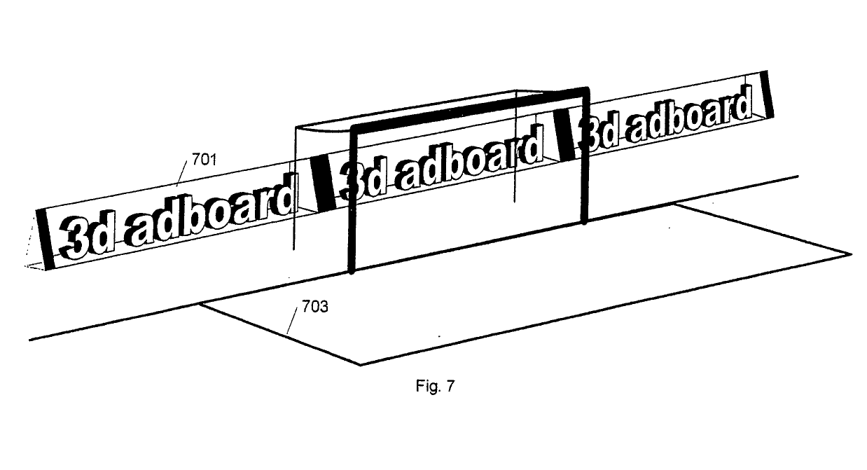

In FIG. 6a and 6b the method according to the present invention is illustrated being performed when designing a print to be used for a print carrier having a predefined surface area being parallel to an inclined plane with an inclination of approximately 90 degrees relative to the ground. In this example, the viewpoint is different from the one used in the example of FIG. 5.

When the projected predefined surface area has been generated as illustrated in 601, the next step is to place the advertisement information within boundaries of the predefined surface area 601. This has been performed in 603. Finally, the stretching is performed for each corner, as shown in 605, until the advertisement print has an area and dimension similar to the area and dimension of the predefined surface of the print carrier on which the print is to be placed. As illustrated in FIG. 6a the stretched design has been positioned on the surface of the advertisement board and when being viewed at, by the viewer, the advertisement appears as illustrated in 600.

In FIG. 7 a sports arena comprising advertisement boards 701 according to the present invention is illustrated. As it can be seen by making dimensions of the three dimensional letters parallel to the lines 703 of the field the illusion becomes very realistic. Further, it can be seen that a virtual space appears to be present within the advertisement board.

A number of examples have been given where the predefined surface area is the surface area of a print carrier being an advertising board, but any kind of predefined surface area could be used. It is just important that the predefined surface area is projected to a plane perpendicular to a line of sight between a predefined viewpoint and the print carrier, and that the design is made within the boundaries of the projected surface area. The predefined surface area could e.g. be circular, square or even another shape, not being a predefined shape.

1. A method of generating an advertisement print (109) comprising advertisement information (105), where the advertisement print is (109) adapted for being positioned on a surface of a substantially plane print carrier, where said surface has a predefined surface area, the method comprises the step of:
projecting the predefined surface area to a plane perpendicular to a line of sight between a predefined viewpoint and said print carrier,
placing the advertisement information within boundaries of said projected predefined surface area (101),
generating said advertisement print by transforming (201, 203, 205, 207) the projected predefined surface area together with the advertisement information to an area similar to said predefined surface area of said substantially plane print carrier.

2. A method according to claim 1, wherein the advertisement information is two-dimensional having a first (104) and a second dimension, and where a first dimension (104) of the advertisement information is made parallel to a boundary (106) of the projected predefined surface area (101).

3. A method according to claim 1, wherein the predefined surface area is the surface area of an advertisement board (701) in a sports arena.

4. A method according to claim 3, wherein a third dimension (110) of the advertising information is made parallel to lines (703) on the sports arena.

5. A method according to claim 1, wherein the predefined viewpoint is defined as the position of a broadcasting camera.

6. An advertisement print (109) comprising advertisement information, where the advertisement print (109) is adapted for being positioned on a substantially plane surface of a print carrier, said surface having a predefined surface area and is parallel to an inclined plane having a first inclination relative to the ground supporting said print carrier of more than 0 degrees, said advertisement print (109) comprising a first element being a perspective projection of at least a first three-dimensional element to said inclined plane, where said perspective projection is based on a predefined viewpoint.

7. An advertisement print according to claim 6, wherein a supporting surface (108) of said three-dimensional element is parallel to a supporting plane (107) having a second inclination being different from said first inclination.

8. An advertisement print according to claim 7, wherein the print further comprises a second element illustrating said supporting plane (107).

9. An advertisement print according to claim 7, wherein the inclination of said supporting plane (107) is substantially the same as the inclination of a surface supporting said print carrier (701).

10. An advertisement print according to claim 6, wherein the surface area of the print carrier is a plane having a first inclination between 0 degrees and 90 degrees, but different from 0 degrees.

11. An advertisement print according to claim 6, wherein the surface area of the print carrier is a plane having a first inclination, whereby the surface area is approximately perpendicular to the surface supporting said print carrier.

12. An advertisement print according to claim 6, wherein the surface of the substantially plane print carrier is the surface of an advertisement board (701) in a sports arena.

13. An advertisement print according to claim 6, wherein the viewpoint is defined as the position of a broadcasting camera.

14. An advertisement print according to claim 6, wherein the three dimensional element comprises three-dimensional letters (105) having a depth (110) extending parallel to the surface supporting said print carrier, whereby the three dimensional letters appear to be supported on a plane being parallel to the surface supporting said print carrier.

15. An advertisement print according to claim 6, wherein at least said first or second element comprises commercial information.

16. An advertisement board (701) in a sports arena comprising a substantially plane print carrier with advertisement print (109) containing advertisement information, where the advertisement print (109) is adapted for being positioned on a surface of the substantially plane print carrier, where the substantially plane print carrier has a predefined surface area, the surface area of the print carrier is a plane having a first inclination relative to the surface supporting the advertisement board being different from 0 degrees, said advertisement print (109) comprising a first element being a perspective projection of at least a first three-dimensional element to said inclined plane, where said perspective projection is based on a predefined viewpoint.

17. An advertisement board according to claim 16, wherein a supporting surface (108) of said three-dimensional element is parallel to a supporting plane (107) having a second inclination being different from said first inclination.

18. An advertisement board according to claim 17, wherein the print further comprises a second element illustrating said supporting plane (107).

19. An advertisement board according to claim 17, wherein the inclination of said supporting plane (107) is substantially the same as the inclination of a surface supporting said advertisement board (701).

20. An advertisement board according to claim 16, wherein the surface area of the print carrier is a plane having a first inclination between 0 degrees and 90 degrees, but different from 0 degrees.

21. An advertisement board according to claim 16, wherein the surface area of the print carrier is a plane having a first inclination, whereby the surface area is approximately perpendicular to the surface supporting said advertisement board.

22. An advertisement board according to claim 16, wherein the viewpoint is defined as the position of a broadcasting camera in the sports arena.

23. An advertisement board according to claim 16, wherein the three dimensional element comprises three-dimensional letters (105) having a depth (110) extending parallel to the surface supporting said advertisement board (701), whereby the three dimensional letters appears to be supported on a plane being parallel to the surface supporting said advertisement board.

24. An advertisement board according to claim 16, wherein at least one dimension of the three dimensional element is parallel to at least one of the lines on the field (703).

25. A sports arena with a field and lines (703) on the field, a broadcasting camera and an advertisement board (701) comprising a substantially plane print carrier with advertisement print (109) containing advertisement information, where the advertisement print (109) is adapted for being positioned on a substantially plane surface of the print carrier, where the substantially plane print carrier has a predefined surface area, the surface area of the print carrier is a plane having a first inclination relative to the surface supporting the advertisement board being different from 0 degrees, said advertisement print (109) comprising a first element being a perspective projection of at least a first three-dimensional element to said inclined plane, where said perspective projection is based on a predefined viewpoint defined as the position of said broadcasting camera.

26. A sports arena according to claim 25, wherein at least one dimension of the three dimensional element is parallel to at least one of the lines (703) on the field.

27. A computer readable medium having stored therein instructions for causing a processing unit to execute the method of claim 1.
